(19) United States
(12) Patent Application Publication
(10) Pub. No.: US 2008/0310047 A1
(43) Pub. Date: Dec. 18, 2008

(54) PORTABLE TYPE INFORMATION PROCESSING APPARATUS

(75) Inventor: Hideyuki Umezu, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/051,406

(22) Filed: Mar. 19, 2008

(30) Foreign Application Priority Data
Jun. 18, 2007 (JP) 2007160540

(51) Int. Cl. G11B 33/14

(52) U.S. Cl. 360/97.02

(57) ABSTRACT

According to one embodiment, a portable type information processing apparatus, including: a judging process unit configured to judge whether a data recording apparatus mounted on the portable type information processing apparatus corresponds to either one of a first data recording apparatus which requires a shock resistant function and a second data recording apparatus which does not require the shock resistant function; and a shock resistant validating process unit configured to validate the shock resistant function if the judging process unit judges that the first data recording apparatus is mounted and invalidate the shock resistant function if the judging process unit judges that the second data recording apparatus is mounted.

### CROSS-REFERENCE TO RELATED APPLICATIONS

This application is based upon and claims the benefit of priority from Japanese Patent Application No. 2007-160540, filed on Jun. 18, 2007, the entire contents of which are incorporated herein by reference.

### BACKGROUND

1. Field

One embodiment of the invention relates to a portable type information processing apparatus on which a data recording apparatus which requires a shock resistant function and another data recording apparatus which does not require a shock resistant function.

2. Description of the Related Art

A video recording apparatus equipped with an acceleration sensor has been disclosed in JP-A-2007-35156. On the video recording apparatus, a semiconductor memory card, or a hard disk drive, which record thereinto video data, is arbitrarily mounted by a user. When the hard disk drive is mounted, the video recording apparatus supplies electric power with respect to the acceleration sensor, whereas when the hard disk drive is not mounted, the video recording apparatus stops the supply of the electric power to the acceleration sensor.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view of a personal computer according to a first embodiment of the invention.

FIG. 2 is a diagram for showing a system arrangement of the personal computer according to the first embodiment.

FIG. 3 is a functional block diagram for representing functions of the personal computer according to the first embodiment.

FIG. 4 is a flow chart for schematically indicating a validating process operation of a shock resistant function according to the first embodiment.

FIG. 5 is a flow chart for describing a process operation by the BIOS.

FIG. 6 is a flow chart for describing an installing process operation.

### DETAILED DESCRIPTION

Various embodiments according to the invention will be described hereinafter with reference to the accompanying drawings. In general, according to one embodiment of the invention, there is provided a portable information processing apparatus comprising a determination unit configured to determine whether a data recording apparatus mounted to the portable information processing apparatus corresponds to a first data recording apparatus which is susceptible to malfunction due to mechanical shock and a second data recording apparatus which is less susceptible to malfunction due to mechanical shock; and a shock resistance process unit configured to activate the shock resistance function if the determination unit determines that the first data recording apparatus is mounted and to deactivate the shock resistant function if the determination unit determines that the second data recording apparatus is mounted.

Referring now to drawings, a detailed description is made of embodiment. It should be understood that the same reference numerals will be employed as those for denoting the same elements, or the same functions in the below-mentioned descriptions, and therefore, repeated explanations thereof will be omitted.

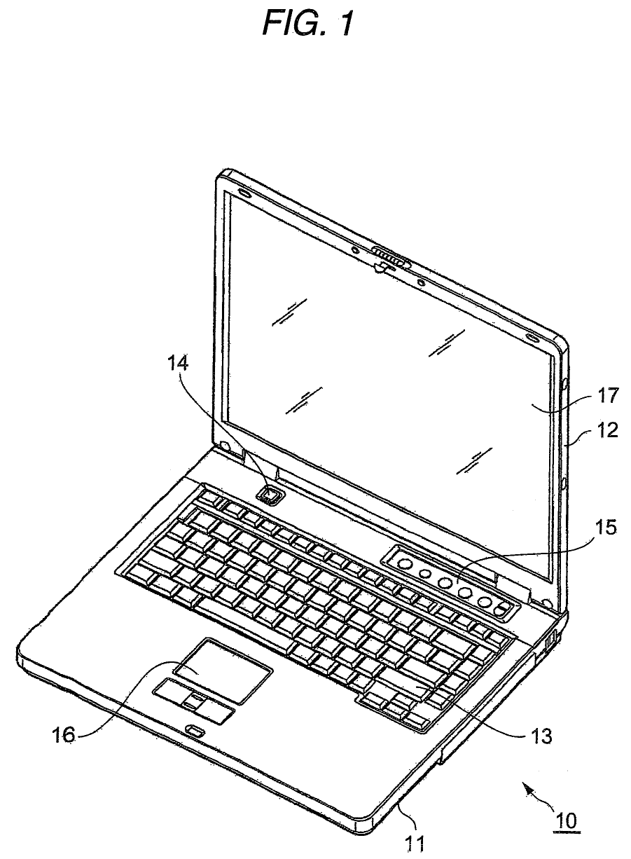

As shown in FIG. 1, a notebook type personal computer (namely, portable type information processing apparatus) 10 has been arranged by a computer main body 11 and a display unit 12. A display device constructed of an LCD (Liquid Crystal Display) 17 has been assembled in the display unit 12, and a display screen of the LCD 17 has been located at a substantially center position of the display unit 12. 014 The display unit 12 has been rotatably mounted between an open position and a close position with respect to the computer main body 11. The computer main body 11 has a box type thin housing. A keyboard 13, a power button 14 for turning ON/OFF a power supply of the personal computer 10, an input operation panel 15, a touch pad 16, and the like have been arranged on an upper plane of the computer main body 11.

Next, a description is made of a system arrangement of the personal computer 10.

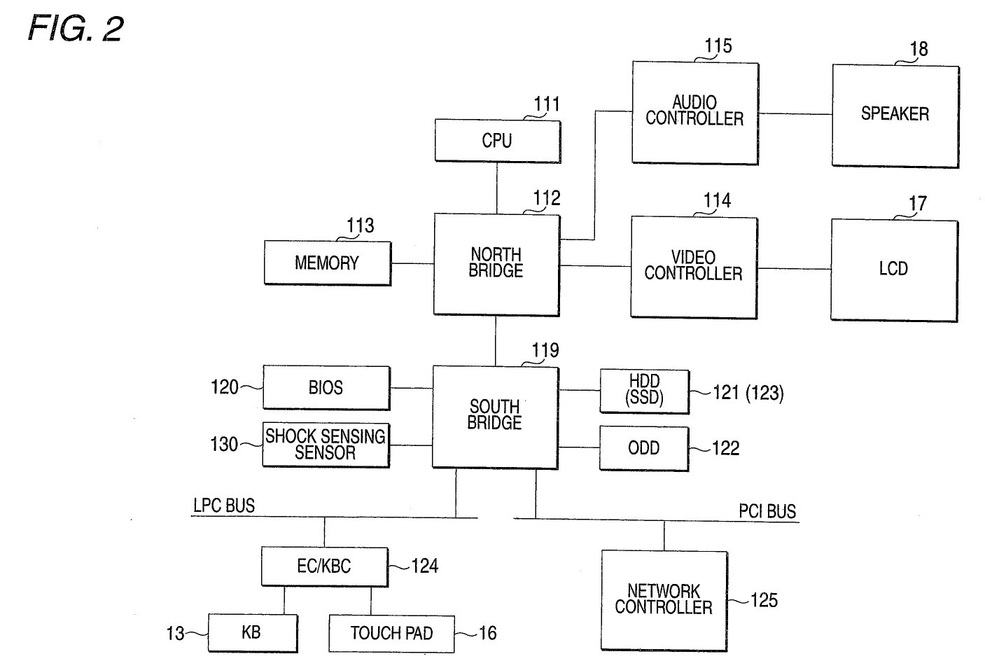

As indicated in FIG. 2, the personal computer 10 has been equipped with a CPU 111, a north bridge 112, a main memory 113, a video controller 114, an audio controller 115, a south bridge 119, a BIOS 120, a hard disk drive (HDD) 121, an optical disk drive (ODD) 122, an embedded control/keyboard controller I C(EC/KBC) 124, a network controller 125, and the like.

The CPU 111 is such a processor provided in order to control operations of the personal computer 10, while the CPU 111 executes an operating system (OS) and various sorts of application programs, which are loaded onto the main memory 113 from the HDD 121. Also, the CPU 111 executes a system BIOS (Basic Input/Output System) stored in the BIOS 120 corresponding to a non-volatile memory. The system BIOS corresponds to a program used to control hardware.

The north bridge 112 corresponds to such a bridge device which connects a local bus of the CPU 111 to the south bridge 119. A memory controller has also been built in the north bridge 112, and executes an access control with respect to the main memory 113. Also, the north bridge 112 has a function for performing a communication operation via an AGP (Accelerated Graphics Port) bus and the like with respect to the video controller 114, and for performing another communication operation with respect to the audio controller 115.

The video controller 114 is a video reproducing controller for controlling the LCD 17 which is used as a display monitor of the personal computer 10. The video controller 114 produces a reproduction signal from decoded picture data, which should be transmitted to the LCD 17.

The audio controller 115 is an audio reproducing controller for controlling a speaker 18 of the personal computer 10. The audio controller 115 produces a reproduction signal from decoded sound data, which should be transmitted to the speaker 18.

The south bridge 119 controls respective devices on an LPC (Low Pin Count) bus, and respective devices on a PCI (Peripheral Component Interconnect) bus. Also, the south bridge 1119 has contained an IDE (Integrated Drive Electronics) controller which is employed so as to control the HDD 121 and the ODD 122.

The HDD 121 corresponds to a storage apparatus for storing thereinto various sorts of software and various sorts of data. The ODD 122 corresponds to a drive unit which drives storage media such as DVD and the like, into which video contents have been stored.

The EC/KBC 124 corresponds to a 1-chip microcomputer on which the embedded controller for managing electric power and the keyboard controller for controlling the keyboard 13 and the touch pad 16 have been formed in an integrated manner. This EC/KBC 124 has a function capable of turning ON/OFF the power supply of the personal computer 10 in response to an operation of the power button 14 by a user. The network controller 125 is such a communication apparatus which performs a communication operation with respect to an external network, for example, the Internet, and so on.

The above-described personal computer 10 corresponds to such a computer model on which the HDD 121 has been mounted as a data recording apparatus, namely, the HDD 121 has been assembled in the personal computer 10 in a manufacturing stage. The HDD 121 is such a data recording apparatus that data is read out from a disk-shaped storage medium while a head is transported. As a consequence, when the HDD 121 receives shock, this HDD 121 may be readily brought into malfunction, and thus requires a shock resistant function capable of protecting the head from the shock. To this end, the personal computer 10 has been equipped with a shock sensing sensor 130 which previously senses that the personal computer 10 receives shock. In this case, the shock sensing sensor 130 senses such a fact that acceleration exceeds a preset threshold value. When the shock sensing sensor 130 senses that acceleration exceeds the threshold value, the CPU 111 executes HDD protection software (namely, shock dealing-purpose software) so as to save the head of the HDD 121 to a safety area where even when the personal computer 10 receives shock, the HDD 121 is not brought into the malfunction.

There are some cases that a solid-state drive (SSD) 123 is mounted on the personal computer 10 instead of the above-described HDD 121. In such a case that the personal computer 10 is such a computer model on which the SSD 123 has been mounted as a data recording apparatus, the SSD 123 is assembled in the personal computer 10 in a manufacturing stage. The SSD 123 corresponds to such a data recording apparatus that data is recorded in a semiconductor memory, namely, the SSD 123 is constituted by employing a NAND flash memory. As a consequence, even when the SSD 123 receives shock, this SSD 123 is hardly brought into malfunction, and therefore, does not require the shock resistant function, which is different from the HDD 121. It should be understood that such a condition that the personal computer 10 is designed as either an HDD-mounted computer model or an SSD-mounted computer model may be determined before the personal computer 10 is manufactured. In the manufacturing stage of the personal computer 10, any one of the HDD 121 and the SSD 123 is assembled in the personal computer 10.

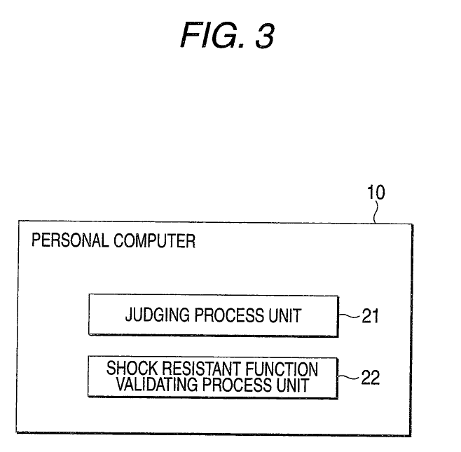

The personal computer 10 has been arranged in such a manner that the personal computer 10 is operable not only in such a case that the data recording apparatus mounted in the manufacturing stage is the HDD 121, but also in such a case that the data recording apparatus mounted in the manufacturing stage is the SDD 123. FIG. 3 is a functional block diagram for showing a function by which the personal computer 10 is operable with both the HDD 121 and the SSD 123. The personal computer 10 has been equipped with a judging process unit 21, and a shock resistant function validating process unit 22. The judging process unit 11 judges whether a data recording apparatus mounted on the personal computer 10 corresponds to the HDD 121, or the SSD 123. When the judging process unit 21 judges that the HDD 121 has been mounted, the shock resistant function validating process unit 22 performs such a process operation for validating the shock resistant function. On the other hand, when the judging process unit 21 judges that the SSD 123 has been mounted, the shock resistant function validating process unit 22 does not perform such a process operation for validating the shock resistant function. As a result, the personal computer 10 can validate the shock resistant function only in the case that the HDD 121 has been mounted, and can invalidate the shock resistant function in the case that the SSD 123 has been mounted. As will be described in the below-mentioned description, the judging process unit 21 is such a function which is mainly realized by that the CPU 11 executes the system BIOS 120 stored in the BIOS 120. Also, the shock resistant function validating process unit 22 is such a function which is mainly realized by that the CPU 111 executes an installation program for installing the HDD protection software.

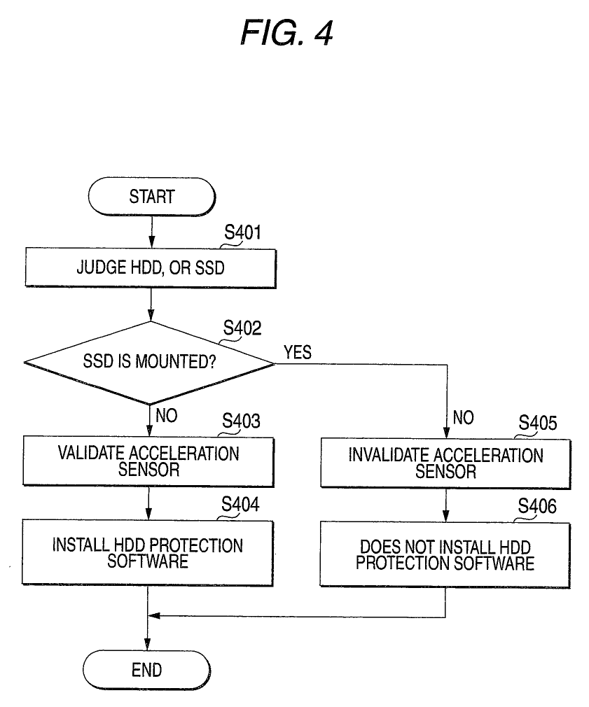

Next, a description is made of a summary of process operations which are executed by the personal computer 10 so as to validate, or invalidate the shock resistant function. FIG. 4 is a flow chart for schematically showing a validating process operation of the shock resistant function. In the flow chart, the personal computer 10 judges whether a data recording apparatus which has been mounted thereon in a manufacturing stage is the HDD 121, or the SSD 123 (steps S401 and S402). In this judging step, when the personal computer 10 judges that the data recording apparatus mounted thereon in the manufacturing stage corresponds to the HDD 121, the personal computer 10 supplies electric power to an acceleration sensor in order to validate the shock resistant function. Also, the personal computer 10 installs the HDD protection software in the HDD 121 (steps S403 and S404). On the other hand, when the personal computer 10 judges that the data recording apparatus mounted thereon in the manufacturing stage corresponds to the SSD 123, the personal computer 10 prohibits the supply of the electric power to the acceleration sensor. Also, while the personal computer 10 does not install the HDD protection software, the personal computer 10 accomplishes the process operations (steps S405 and S406).

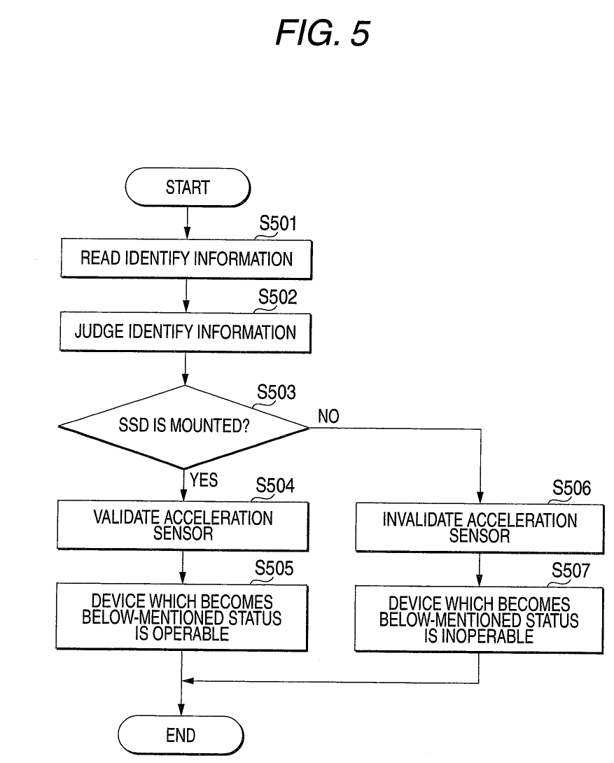

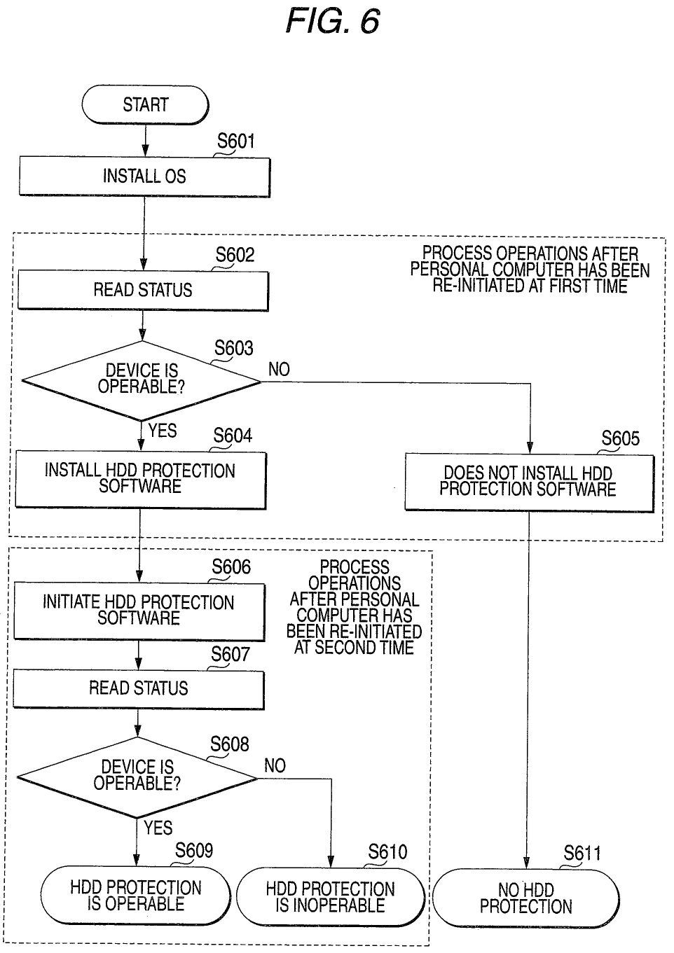

Next, a description is made of process operations for validating, or invalidating the shock resistant function in more detail. FIG. 5 is a flow chart for describing a series of process operations when the CPU 111 executes the system BIOS 120. FIG. 6 is a flow chart for describing a series of process operations when the CPU 111 performs an installation of the operating system (OS), and also executes an installation of the HDD protection software.

As indicated in FIG. 5, when the power supply of the personal computer 10 is turned ON, the CPU 111 reads the system BIOS 120 from the BIOS 120 so as to execute the read system BIOS 120. Identify information (identification information) has been stored in either the HDD 121 or the SSD 123, which has been mounted on the personal computer 10, while the Identify information is employed in order to identify that the mounted data recording apparatus is the HDD 121, or the SSD 123. The CPU 111 reads the Identify information from either the HDD 121 or the SSD 123, and judges whether the data recording apparatus corresponds to the HDD 121, or the SSD 123 based upon this read Identify information (steps S501, S502, and S503).

In such a case that the CPU 111 judges that the data recording apparatus mounted on the personal computer 10 corresponds to the HDD 121, the CPU 111 performs a process operation for supplying electric power to the shock sensing sensor 130 (step S504). As a consequence, the shock sensing sensor 130 may be brought into such a condition that this shock sensing sensor 130 is capable of sensing shock with respect to the personal computer 10. Also, the CPU 111 sets statuses of devices to “operable statuses”, which are employed in order to protect the shock sensing sensor 130 and the HDD 121 such as a head driving-purpose motor (step S505).

On the other hand, in such a case that the CPU 111 judges that the data recording apparatus mounted on the personal computer 10 corresponds to the SSD 123, the CPU 111 prohibits supplying of the electric power to the shock sensing sensor 130 (step S506). As a consequence, since the shock sensing sensor 130 does not consume the unnecessary electric power, the personal computer 10 can be operated for a long time only by being supplied from a battery. Also, the CPU 111 sets statuses of devices to “inoperable statuses”, which are employed in order to protect the shock sensing sensor 130 and the HDD 121 such as a head driving-purpose motor (step S507).

It should also be noted that in the above-described process operations realized by that the CPU 111 executes the system BIOS 120, the process operation for judging either the HDD 121 or the SSD 123 corresponds to the judging process unit 21 of FIG. 3. Also, in the above-described process operations, the process operation for validating, or invalidating the shock sensing sensor 130 corresponds to the shock resistant function validating process unit 22 of FIG. 3.

In the present embodiment, since the BIOS 120 is constructed in the above-described manner, commonly using of the BIOS 120 may be realized irrespective of such a condition that the HDD 121 has been mounted on the personal computer 10, or the SSD 123 has been mounted on the personal computer 10. Commonly using of the BIOS 120 will now be explained in comparison with the conventional technique.

In the conventional technique, in the BIOS 120 which is installed in the personal computer 10 equipped with the HDD 121, the status of the device which is employed in order to protect the HDD 121 must be set to “operable status.” On the other hand, in the BIOS 120 which is installed in the personal computer 10 equipped with the HDD 123, the status of the device which is employed in order to protect the HDD 121 must be set to “inoperable status.” As a consequence, in the conventional technique, the BIOS 120 different from each other must be installed in the personal computer 10 in response to the sort (HDD/SSD) of data recording apparatuses which are mounted on the personal computers 10.

To the contrary, as to the BIOS 120 of the present embodiment, a sort of data recording apparatus which is mounted on the personal computer 10 is judged, and then, a status of a device is switched which is employed in order to protect the HDD 121 in response to this judgement result. As a consequence, the BIOS 120 which is installed in the personal computer 10 equipped with the HDD 121, and the BIOS 120 which is installed in the personal computer 10 equipped with the SSD 123 can be commonly used. As previously described, since the BIOSs 120 are commonly used, the cost required for developing and manufacturing the personal computer 10 can be reduced, and furthermore, the BIOSs 120 can be readily managed when the personal computer 10 is manufactured.

Next, a description is made of a series of process operations performed in the case that the CPU 111 installs software. As indicated in FIG. 6, when the manufacturing stage of the personal computer 10 is accomplished, a pre-installing process operation of software is carried out before the manufactured personal computer 10 is shipped. In this flow chart, a step S601 corresponds to a process operation for pre-installing the operating system (OS). Steps S602 to S605 correspond to such a process operation that after the personal computer 10 has been re-initiated at a first time, the HDD protection software is pre-installed. Steps S606 to S610 correspond to a process operation executed after the personal computer 10 has been re-initiated at a second time.

When the personal computer 10 is initiated by employing the above-described BIOS 120, the CPU 111 executes an installation program for installing the operating system in either the HDD 121 or the SSD 123 (step S601). Next, when the personal computer 10 is re-initiated so as to operate the operating system (OS), the CPU 111 executes an installation program for pre-installing the HDD protection software in either the HDD 121 or the SSD 123.

In order to pre-install the HDD protection software, the CPU 111 firstly reads a status set by the BIOS 120 (step S602). Then, the CPU 111 judges whether the device employed in order to protect the HDD 121 is “operable status” or “inoperable status” based upon the read status (step S603). In this step, when the CPU 111 judges that the device employed in order to protect the HDD 121 is “operable status” (“YES” in step S603), the CPU 111 installs the HDD protection software (step S604). On the other hand, when the CPU 111 judges that the device employed in order to protect the HDD 121 is “inoperable status” (“NO” in step S603), the CPU 111 does not install the HDD protection software (step S605).

Next, when the personal computer 10 is re-initiated so as to operate the HDD protection software, the CPU 111 initiates the HDD protection software so as to read the status set by the BIOS 120 (steps S606 and S607). Then, the CPU 111 judges whether the device employed in order to protect the HDD 121 is “operable status”, or “inoperable status” based upon the read status (step S608). In this step, when the CPU 111 judges that the device employed in order to protect the HDD 121 is “operable status” (“YES” in step S608), the CPU 111 can perform a process operation based upon the HDD protection software (step S609). On the other hand, when the CPU 111 judges that the device employed in order to protect the HDD 121 is “inoperable status” (“NO” in step S608), the CPU 111 cannot perform the process operation based upon the HDD protection software (step S610). The step S610 corresponds to a protection process operation when a certain error occurs in the personal computer 10.

It should be understood that in such a case that the HDD protection software is not installed in the step S605, the HDD protection software is not initiated even after the personal computer 10 is re-initiated. As a result, the process operation based upon the HDD protection software is not carried out (step S611).

The personal computer 10 of the present embodiment judges the data recording apparatus which has been mounted on the personal computer 10, and when the data recording apparatus is the HDD 121, the HDD protection software is installed so as to validate the shock resistant function for protecting the HDD 121. On the other hand, when the data recording apparatus is the SSD 123, the personal computer 10 does not install the HDD protection software in order to invalidate the shock resistant function for protecting the HDD 121. As a result, in the case that the data recording apparatus is the SSD 123, it is possible to avoid that the unnecessary HDD protection software is installed.

Also, in accordance with the personal computer 10 of the present embodiment, the pre-installation program for the HDD 121 and the SSD 123 is commonly used, so that the cost required for developing and manufacturing the personal computer 10 can be reduced, and further, the pre-installing operations executed when the personal computer 10 is manufactured can be easily managed.

In the personal computer 10 according to the above-explained embodiment, the BIOS 120 and the pre-installation program have been designed by considering the computer model equipped with the HDD 121 and the computer model equipped with the SSD 123. Alternatively, in other information processing apparatuses, the BIOS 120 and the pre-installing process operation may be designed by furthermore considering other models. For instance, in such a case that there are two computer models, namely the personal computer 10 equipped with an ODD and the personal computer 10 not equipped with the ODD, the BIOS 120 and the pre-installation program may be designed by considering whether or not the ODD is provided in the personal computer 10. While certain embodiments of the invention have been described, these embodiments have been presented by way of example only, and are not intended to limit the scope of the invention. Indeed, the novel methods and systems described herein may be embodied in a variety of other forms; furthermore, various omissions, substitutions and changes in the form of the methods and systems described herein may be made without departing from the scope of the invention. The accompanying claims and their equivalents are intended to cover such forms or modifications as would fall within the scope of the invention.

In accordance with the above-mentioned embodiment, it is possible to provide the portable type information processing apparatus in which when the data recording apparatus for requiring the shock resistant function is mounted thereon, the shock resistant function is prepared, whereas when the data recording apparatus for not requiring the shock resistant function is mounted thereon, the shock resistant function is not prepared.

What is claimed is:

1. A portable information processing apparatus, comprising:
a determination unit configured to determine whether a data recording apparatus mounted to the portable information processing apparatus corresponds to either a first data recording apparatus which is susceptible to malfunction due to mechanical shock, or a second data recording apparatus which is less susceptible to malfunction due to mechanical shock; and
a shock resistance process unit configured to activate a shock resistance function if the determination unit determines that the first data recording apparatus is mounted and to deactivate the shock resistance function if the determination unit determines that the second data recording apparatus is mounted.

2. The portable information processing apparatus of claim 1, wherein the shock resistance process unit is configured to activate the shock resistance function by installing shock resistance software.

3. The portable information processing apparatus of claim 2, further comprising an installation program for installing a shock resistance program, wherein the installation program for installing a shock resistance program comprises the shock resistance process unit.

4. The portable information processing apparatus of claim 1, wherein the shock resistance process unit is configured to activate the shock resistance function by supplying electric power to a shock sensing sensor.

5. The portable information processing apparatus of claim 4 further comprising a Basic Input/Output System (BIOS), wherein the BIOS comprises the shock resistance function process unit.

6. The portable information processing apparatus of claim 1, wherein the determination unit is configured to acquire information regarding the type of the mounted data recording apparatus, and
wherein the determination unit is configured to determine whether the mounted data recording apparatus is either the first data recording apparatus or the second data recording apparatus based upon the acquired information.

7. The portable information processing apparatus of claim 1, wherein, if the determination unit determines that the mounted data recording apparatus is the first data recording apparatus, the determination unit is configured to set a shock resistance device to be operable, and if the determination unit determines that the mounted data recording apparatus is the second data recording apparatus, the determination unit is configured to set the shock resistance device to be inoperable.

8. A portable information processing apparatus of claim 7, wherein, if the shock resistance device is operable, the shock resistance function process unit is configured to install the shock resistance software.

9. A portable information processing apparatus of claim 1, wherein the first data recording apparatus comprises a data recording apparatus which has a head for reading data from a storage medium, and wherein the second data recording apparatus comprises a data recording apparatus which does not have a head for reading data from the storage medium.

10. A portable information processing apparatus of claim 9 wherein the first data recording apparatus comprises a hard disk drive, and wherein the second data recording apparatus comprises a solid-state drive.

11. A portable information processing apparatus of claim 1, further comprising a Basic Input/Output System (BIOS), wherein the BIOS comprises the determination unit.

12. A program product for enabling a portable information processing apparatus to judge a data recording apparatus mounted on the portable type information processing apparatus, comprising:
a determination unit configured to determine whether the data recording apparatus corresponds to either a first data recording apparatus which is susceptible to malfunction due to mechanical shock or a second data recording apparatus which is less susceptible to malfunction due to mechanical shock; and
a shock resistance process unit configured to activate a shock resistance function if the determination unit determines that the first data recording apparatus is mounted and to deactivate the shock resistant function if the determination unit determines that the second data recording apparatus is mounted.

13. The program product of claim 12, wherein the determination unit is configured to acquire information regarding the type of the mounted data recording apparatus, and
wherein the determination unit is configured to determine whether the mounted data recording apparatus is either the first data recording apparatus or the second data recording apparatus based upon the acquired information.

14. The program product of claim 12, wherein, if the determination unit determines that the mounted data recording apparatus is the first data recording apparatus, the determination unit is configured to set a shock resistance device to be operable, and
if the determination unit determines that the mounted data recording apparatus is the second data recording apparatus, the determination unit is configured to set the shock resistance device to be inoperable.

15. The program product of claim 12, wherein, if the shock resistance device is operable, the shock resistance function process unit is configured to install the shock resistance software, and
wherein, if the shock resistance device is inoperable, the shock resistant function validating process unit is configured to not install the shock resistance software.
